(19) United States
(12) Patent Application Publication
(10) Pub. No.: US 2012/0099794 A1
(43) Pub. Date: Apr. 26, 2012

(54) RETARGETING OF IMAGE WITH OVERLAY GRAPHIC

(75) Inventors: Mathias Hubertus Godefrida Peeters, Eindhoven (NL); Jelte Peter Vink, Eindhoven (NL)

(73) Assignee: KONINKLIJKE PHILIPS ELECTRONICS N.V., EINDHOVEN (NL)

(21) Appl. No.: 13/382,411

(22) PCT Filed: Jul. 2, 2010
(86) PCT No.: PCT/IB10/53051

§ 371 Date: Jan. 5, 2012

(30) Foreign Application Priority Data
Jul. 6, 2009 (EP) 09305651.3

(51) Int. Cl. G06K 9/46

(52) U.S. Cl. 382/190

(57) ABSTRACT

A method for retargeting an image being defined by a matrix of pixels and comprising an overlay graphic, comprises:•extracting (11) the overlay graphic from the image;•modifying (13) the image by replacing the pixels at the location of the overlay graphic with pixels neutral to an energy function;•calculating (15) a saliency map of the modified image based on the pixel energy function;•retargeting (17) the modified image based on the saliency map;•adding back (19) the overlay graphic to the retargeted image.

### FIELD OF THE INVENTION

The invention relates to a method for image retargeting. The invention equally relates to a corresponding apparatus and a computer program product comprising instructions for implementing the steps of the method.

### BACKGROUND OF THE INVENTION

Recent developments in the field of display technologies have seen great diversity in display sizes. Displays vary from low resolution hand-held devices to high definition wide-screen TVs. Computing and communication infrastructures are evolving to support images and video into this ever expanding set of potential displays. Visual content is becoming more important for sharing, expressing, and exchanging information on devices such as cell phones and hand-held personal computers (PCs), personal digital assistants (PDAs) with video capabilities and home-networked media appliances. The same content is required to be displayed in different dimensions and aspect ratios for different devices. Standard image processing methods of scaling and cropping are not proving to be sufficient.

With the popularity of wide-screen TVs, efficient solutions that could effectively display video on displays other than originally intended is needed. Traditionally TVs implement a method called “black bar detection” to automatically adjust the aspect ratio. The video is scaled in such a way that the black bars disappear. This is especially done in modern wide screen flat TVs for letter boxed widescreen content. However, for displaying 4:3 contents on widescreen TVs, the scaling adjustment gives distortions.

U.S. Pat. No. 7,339,627 by Brian Schoner et al. describes a method for aspect ratio correction based on black bars surrounding the image. While applied in TVs in the market, this method has the disadvantage that it fails if the source video is encoded incorrectly (such as many videos downloaded from the Internet show), or for movies in 2.35:1 movie aspect ratio, which requires to be shown with black bars even on a 16:9 widescreen TV.

In Philips TVs, a technique of Panoramic Stretch is used for displaying 4:3 content on 16:9 display, where the boundaries of an image are stretched to take up the wider screen. Although the assumption on which the method is based, i.e. most essential information is in the centre view, is often a good one, there are many cases where such an anisotropic stretch is not the optimal solution. Better methods are desired for enabling effective resizing for a variety of displays.

When simple aspect ratio correction is not enough to render the image suitable for viewing, image retargeting is invoked. Retargeting is scaling the image while taking the content, the important objects in the scene, in consideration. It is therefore often called content-aware resizing. Different retargeting methods identify important image features, either based on low level visual saliency, or high level image understanding through tools like face detection. Based on the important features, retargeting methods try to modify the image in the less important areas to resize to target size.

A retargeting method is typically useful when it is needed to stretch 4:3 content to a 16:9 display or all regular content to a 21:9 display.

### SUMMARY OF THE INVENTION

When the image comprises one scene with superimposed pictures, called overlay graphics, such as subtitles, logos, etc., retargeting methods do not result in a nice looking retargeted image. For instance, the subtitles are distorted by the non-uniform scaling of content-aware resizing.

Furthermore, the overlay graphics usually influence the energy function used by retargeting methods, leading to sub-optimal results. For instance, as energy functions are often based on gradients in the image, the high contrasts and sharp edges that are usually seen in overlay graphics, and particularly in subtitles, might, depending on the image content, lead to larger distortions elsewhere in the image.

Therefore it would be advantageous to achieve a retargeting method that does not distort the appearance of the overlay graphics and for which the overlay graphics has no impact on the image retargeting.

To better address one or more of these concerns, in a first aspect of the invention a method for retargeting an image being defined by a matrix of pixels and comprising an overlay graphic, comprises:
extracting the overlay graphic from the image;
modifying the image by replacing the pixels at the location of the overlay graphic with pixels neutral to an energy function;
calculating a saliency map of the modified image based on the pixel energy function;
retargeting the modified image based on the saliency map;
adding back the overlay graphic to the retargeted image.

Advantageously, the method separates the image from the overlay graphic before retargeting processing. The image and the overlay graphic are mixed together again after the retargeting treatment.

Consequently, the overlay graphic does not influence the energy function and is not distorted by a non-uniform scaling.

In particular embodiments,
the overlay graphic is adjusted before being added back; for instance the overlay graphic is adjusted by scaling for adapting the overlay graphic dimension to the retargeted image dimension, resolution enhancement and contrast enhancement, so that the overlay graphic is displayed with a pleasant look;
the modified image is retargeted by seam carving using the defined pixel energy function, although other retargeting methods are also usable;
the pixel energy function is based on gradients in the image, and the replacing pixels are averages of the surrounding pixels to minimize the energy brought by the replacing pixels;
when the overlay graphic is added back, the position and the size of the overlay graphic are adjusted to minimize artifacts introduced by the overlay graphic extraction on the retargeted image; for instance, the overlay graphic position and size are stored before extraction and said position and said size are resized together with the image during retargeting to define the new position and size of the added back overlay graphic, so that the adjusted overlay graphic hides at least partly the area where the replacing pixels were put.
a second image is generated after extraction of the overlay graphic by replacing the overlay graphic pixels with pixels adapted to the image content, the second image, instead of the modified image, being retargeted based on the calculated saliency map which has the advantage to separate the computation of the saliency map from the image which is retargeted bringing together the best of the two operations.

In a second aspect of the invention a computer program product comprises instructions for implementing the steps of the method disclosed here above when loaded and run on computer means of an apparatus.

In a third aspect of the invention, an apparatus for retargeting an image, comprises:
a receiver for obtaining an image, said image being defined by a matrix of pixels and comprising an overlay graphic;
an extractor of the overlay graphic from the image;
an image modifier modifying the image by replacing the pixels at the location of the overlay graphic with pixels neutral to an energy function;
a saliency map calculator of said modified image based on the pixel energy function;
a scaler for retargeting said modified image based on said saliency map;
a synthesizer for adding back the overlay graphic to the retargeted image.

Depending on the type of image, a particular embodiment may be preferred as easier to adapt or as giving a better result. Aspects of these particular embodiments may be combined or modified as appropriate or desired, however.

These and other aspects of the invention will be apparent from and elucidated with reference to the embodiment described hereafter where:

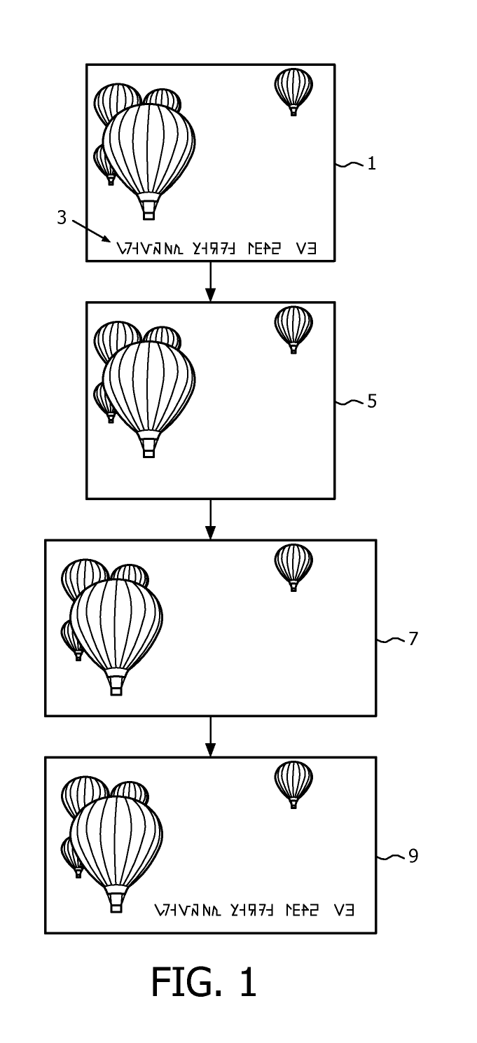

FIG. 1 is a schematic view of the result of different steps of a method according to an embodiment of the invention;

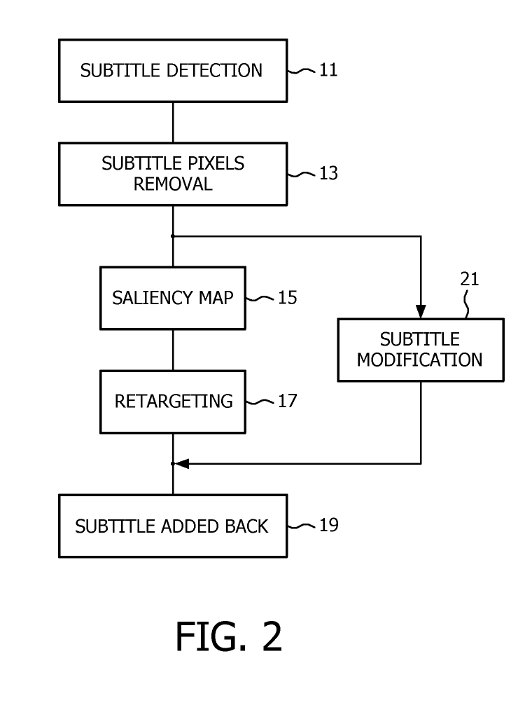

FIG. 2 is a flow chat of a method according to an embodiment of the invention

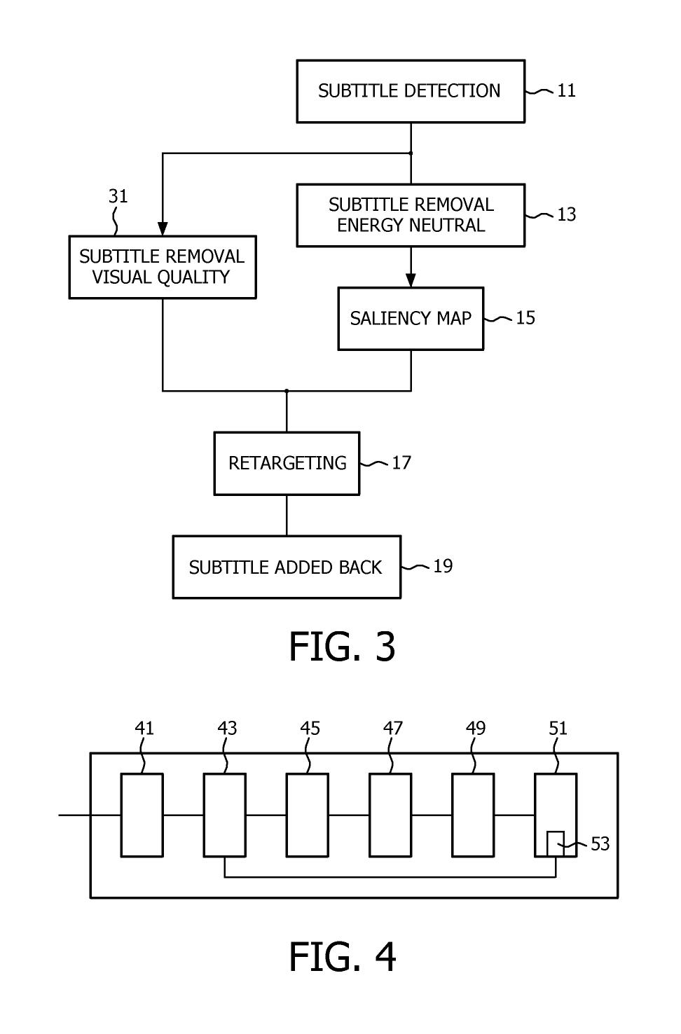

FIG. 3 is a flow chart of a method according to another embodiment of the invention; and

FIG. 4 is a schematic view of an apparatus according to an embodiment of the invention.

In reference to FIG. 1, an image 1 comprises subtitles 3. Subtitles are examples of overlay graphics. Other overlay graphics are logos, ticker tapes, score boards for sport matches, etc.

In a first step, subtitles 3 are removed from the image 1 to obtain image 5.

Then image 5 is retargeted into an image 7 on which the subtitles 3 are added back to obtain the final retargeted image 9.

The method for retargeting the image 1 is now described in details in reference to FIG. 2.

A retargeting method uses generally a pixel energy function, for instance a function based on gradient. When applied to an image, the pixel energy function defines a saliency map which is used by the retargeting method to focus the scaling operations on the low saliency areas.

At step 11, the subtitles are detected. This can be done using an available algorithm for subtitle detection, such as, for example, the algorithm disclosed in US 2002/0159636 assigned to R. Lienhart et al.

All pixels that are marked as subtitle pixels are removed, step 13, form the image by replacing these pixels with a pixel value that is neutral to the energy function, i.e. that introduces no, or a very limited, energy. For example, for energy functions based on gradient, each subtitle pixel may be replaced by the averages of the surrounding pixels. As another example, an in-painting algorithm may be used to replace the subtitle pixels.

The energy function is applied to the modified image, step 15, to calculate a saliency map.

And the modified image, step 17, is retargeted based on the saliency map. It is worthwhile to note that the calculation of the saliency map and the retargeting may be combined in a unique step, depending on the retargeting algorithm used.

As example of a usable retargeting algorithm for the disclosed method, seam carving may be cited. Seam carving is disclosed, for instance, in US 2008/0267528 assigned to Avidan et al. where the saliency map is called “energy image”.

The image being retargeted, subtitles are added back, step 19. Preferably, the size and the location of the subtitles, when placed in the retargeted image, are such that the subtitles mask possible image artifacts that have been introduced while removing the subtitles from the original image. For masking these artifacts, the location of the subtitles in the original image may be remembered and this information is resized together with the image during the retargeting step.

Therefore, before being added back, the subtitles may be modified, step 21. For instance, depending on the resizing that takes place, a scaling step may be applied to the subtitles to adjust the subtitle size to the display size and format.

Other modifications may include contrast enhancement, resolution enhancement, etc.

As the pixel locations of the subtitles have been filled with values that have minimum influence on the energy function, the performance of the retargeting algorithm is no longer influenced by the presence of subtitles.

However, the replacement by neutral pixels may not be efficient from the point of view of the visual quality of the image. Therefore, a variant is disclosed in relation with FIG. 3 where identical steps have the same reference number. In parallel to step 13 of replacement of subtitle pixels by neutral pixels, a second image is created, step 31, where the subtitle pixels are replaced by pixels having a pleasing look, i.e. being adapted to the image content, for instance, by interpolating from the surrounding pixels.

In this variant, the saliency map is calculated, step 15, from the image where the subtitle pixels have been replaced by neutral pixels. But the retargeting operation, step 17, uses the saliency map onto the second image, i.e. the pleasing look image. Other steps are similar. For instance, subtitles may also be modified as in step 21 of FIG. 2. The method may be implemented by a computer program product that is able to implement any of the method steps as described above when loaded and run on computer means of an image resizing apparatus. The computer program may be stored/distributed on a suitable medium supplied together with or as a part of other hardware, but may also be distributed in other forms, such as via the Internet or other wired or wireless telecommunication systems.

An integrated circuit may be arranged to perform any of the method steps in accordance with the disclosed embodiments.

For instance, a HD TV, or a wide-screen TV may contain an apparatus for retargeting the video images before displaying them.

The apparatus comprises, FIG. 4:
a receiver 41 for obtaining an image, the image being defined by a matrix of pixels and comprising an overlay graphic;
an extractor 43 of the overlay graphic from the image;
an image modifier 45 modifying the image by replacing the pixels at the location of the overlay graphic with pixels neutral to an energy function;
a saliency map calculator 47 of the modified image based on the pixel energy function;
a scaler 49 for retargeting the modified image based on the saliency map;
a synthesizer 51 for adding back the overlay graphic to the retargeted image.

The synthesizer 51 may comprise an overlay graphic modifier 53 for adjusting the overlay graphic before it is added back.

While the invention has been illustrated and described in details in the drawings and foregoing description, such illustration and description are to be considered illustrative or exemplary and not restrictive; the invention is not limited to the disclosed embodiment.

Other variations to the disclosed embodiments can be understood and effected by those skilled on the art in practicing the claimed invention, from a study of the drawings, the disclosure and the appended claims. In the claims, the word “comprising” does not exclude other elements and the indefinite article “a” or “an” does not exclude a plurality.

1. Method for retargeting an image, said image being defined by a matrix of pixels and comprising an overlay graphic, comprising:
extracting (11) the overlay graphic from the image;
modifying (13) the image by replacing the pixels at the location of the overlay graphic with pixels neutral to an energy function;
calculating (15) a saliency map of said modified image based on the pixel energy function;
retargeting (17) said modified image based on said saliency map;
adding back (19) the overlay graphic to the retargeted image.

2. Method according to claim 1, wherein the overlay graphic is adjusted before being added back.

3. Method according to claim 2, wherein the overlay graphic is adjusted by at least one of the following operations: scaling for adapting the overlay graphic dimension to the retargeted image dimension, resolution enhancement and contrast enhancement.

4. Method according to claim 1, wherein the modified image is retargeted by seam carving, said seam carving using the defined pixel energy function.

5. Method according to claim 1, wherein the pixel energy function is based on gradients in the image.

6. Method according to claim 1, wherein the replacing pixels are averages of the surrounding pixels.

7. Method according to claim 1, wherein, when the overlay graphic is added back, the position and the size of the overlay graphic are adjusted to minimize artifacts introduced by the overlay graphic extraction on the retargeted image.

8. Method according to claim 7, wherein the overlay graphic position and size are stored before extraction and said position and said size are resized together with the image during retargeting to define the new position and size of the added back overlay graphic.

9. Method according to claim 1, wherein a second image is generated after extraction of the overlay graphic by replacing the overlay graphic pixels with pixels adapted to the image content, said second image, instead of the modified image, being retargeted based on said calculated saliency map.

10. Method according to claim 1, wherein the overlay graphic is at least one of subtitle, logo, ticker tape and score board.

11. Computer program product comprising instructions for implementing the steps of a method according to claim 1 when loaded and run on computer means of an apparatus.

12. Apparatus for retargeting an image, comprising:
a receiver (41) for obtaining an image, said image being defined by a matrix of pixels and comprising an overlay graphic;
an extractor (43) of the overlay graphic from the image;
an image modifier (45) modifying the image by replacing the pixels at the location of the overlay graphic with pixels neutral to an energy function;
a saliency map calculator (47) of said modified image based on the pixel energy function;
a scaler (49) for retargeting said modified image based on said saliency map;
a synthesizer (51) for adding back the overlay graphic to the retargeted image.

13. Apparatus according to claim 12, wherein the synthesizer comprises an overlay graphic modifier for adjusting the overlay graphic before said overlay graphic is added back.

14. Apparatus according to claim 13, wherein said overlay graphic modifier is able to proceed to at least one of the following operations: scaling for adapting the overlay graphic dimension to the retargeted image dimension, resolution enhancement and contrast enhancement.
